(19) United States
(12) Patent Application Publication
(10) Pub. No.: US 2006/0031190 A1
(43) Pub. Date: Feb. 9, 2006

(54) System and method for managing outgoing communications

(76) Inventors: Ryan Busnardo, Corona, CA (US); Scot Demmer, Vista, CA (US); Bruce Low, Monrovia, CA (US); Andrew Lewis, Newport Beach, CA (US)

Correspondence Address: James P. Broder;Law Office of Steven G. Roeder, 5560 Chelsea Ave., La Jolla, CA, 92037, US

(21) Appl. No.: 10/913,176

(22) Filed: Aug. 6, 2004

(51) Int. Cl. G06F 17/00

(52) U.S. Cl. 707/2

(57) ABSTRACT

A communication manager (10) for managing outgoing communications from a source (12) to a destination (14) includes a sequence receiver (24), a database interface (26) and a controller (28). The sequence receiver (24) receives a first destination sequence from the source (12). The database interface (26) interfaces with a first database (DB1) including a plurality of first database sequences and a second database (DB2) including a second database sequence. The controller (28) compares the first destination sequence to one or more of the first database sequences. The controller (28) selectively transmits the second database sequence to a communication carrier (18) or the source (12) depending upon whether the first destination sequence is substantially similar to one of the first database sequences, and whether the second database sequence is substantially similar to one of the first database sequences. The second database sequence can include an alternative telephone number or other data for the destination (14). The database interface (26) can also interface with a third database (DB3) that includes a plurality of third database sequences. In this embodiment, whether the controller (28) selectively transmits the second database sequence can depend upon whether the second database sequence is substantially similar to any of the third database sequences.

### FIELD OF THE INVENTION

The present invention is directed toward a computerized system and method for managing outgoing communications.

### BACKGROUND

The communications world is becoming more and more technologically advanced each year. Consequently, a greater number of modes of communication are not only available, but are often required for businesses and individuals just to keep up with today's breakneck technological pace. Because more avenues for communication with others are possible, privacy concerns have become more prevalent than ever before. For example, certain businesses and individuals may desire not to receive solicitations over various forms of communication such as by telephone or by computer, such as electronic mail or other messaging applications.

Recently, individuals have been given an opportunity to register one or more of their phone numbers on a state, federal or other similar “Do-Not-Call” (DNC) registry or list. Once on a DNC list, these individuals may not be contacted for certain types of telephone solicitations. These lists are maintained in one or more databases that are periodically updated as individuals choose to add or remove their phone number(s) from the list. State and/or federal regulations provide that non-exempted telemarketers and other telephone solicitors may be subject to monetary fines, injunctions and/or other civil penalties for attempting such solicitations to individuals who have registered on one or more DNC lists. Further, other somewhat similar prohibitory lists may be established in the future for electronic mail or other types of messaging applications.

On the other hand, it can be critical for various businesses to maintain communications with their clients and customers, without fear that these businesses will inadvertently contact an individual having a phone number or an electronic mail address on a DNC list. Moreover, certain companies have a need to contact individuals based on customer recommendations and referrals, while at the same time steering clear of prohibited phone numbers included in the DNC databases. Additionally, the efficiency of contacting a list of individuals can be greatly decreased due to the time required to manually search one or more of the DNC databases prior to placement of each separate telephone call.

In light of the above, a need exists for a more efficient manner of contacting customers, clients and/or other individuals while decreasing the likelihood of violating provisions governing any state or federal “Do-Not-Call” lists or other similar prohibitory lists.

### SUMMARY

The present invention is directed toward a communication manager that manages outgoing destination sequences. The destination sequences include a first destination sequence that originates from a source for communication with a destination via a communication carrier. In one embodiment, the communication manager includes a sequence receiver, a database interface and a controller. The sequence receiver receives the first destination sequence from the source during an outgoing communication. The database interface interfaces with (i) a first database including a plurality of first database sequences, and (ii) a separate second database including a second database sequence. The controller is in electrical communication with the sequence receiver and the database interface. The controller compares the first destination sequence to one or more of the first database sequences. The controller then selectively transmits the second database sequence to one of the communication carrier and the source depending upon (i) whether or not the first destination sequence is substantially similar to one of the first database sequences, and (ii) whether or not the second database sequence is substantially similar to one of the first database sequences in the first database. In one embodiment, the controller only transmits the second database sequence when the first destination sequence is identical to one of the first database sequences.

In still another embodiment, the controller only transmits the second database sequence when the first destination sequence is substantially similar to one of the first database sequences. In an alternative embodiment, the controller only transmits the second database sequence when the second database sequence is not substantially similar to one of the first database sequences. In yet another embodiment, the controller only transmits the second database sequence when the first destination sequence is substantially similar to one of the first database sequences. The second database sequence can include one or more of an alternative telephone number, a mailing address, a facsimile number, a web address, an electronic mail address and an instant messenger username, each for the first destination. Moreover, the second database sequence can be communicated to the source using various methods, including electronic mail, text messaging, facsimile and/or audio transmission.

In another embodiment, the database interface interfaces with a separate third database that includes a plurality of third database sequences. In this embodiment, whether the controller selectively transmits the second database sequence can depend upon whether the second database sequence is substantially similar to any of the third database sequences.

The present invention is also directed to a method for managing outgoing destination sequences.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a block diagram of a system that utilizes one embodiment of the communication manager having features of the present invention;

FIG. 2A is a flowchart describing operation of a first embodiment of the communication manager;

FIG. 2B is a flowchart describing operation of another embodiment of the communication manager;

FIG. 3A is a flowchart describing operation of yet another embodiment of the communication manager;

FIG. 3B is a flowchart describing operation of still another embodiment of the communication manager; and

FIG. 3C is a flowchart describing operation of another embodiment of the communication manager.

### DESCRIPTION

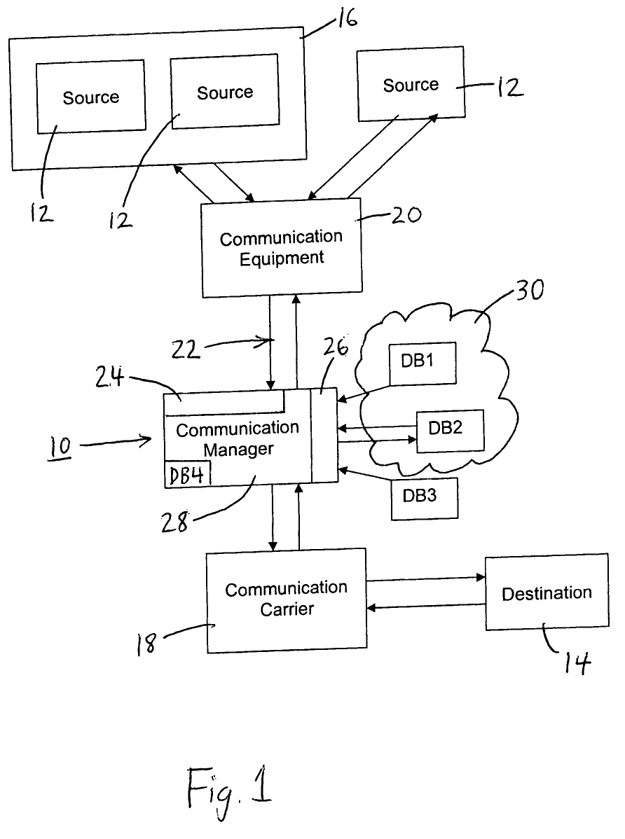

Referring to FIG. 1, the present invention is directed toward a communication manager 10 and method for managing attempted outgoing communications from a source 12 to one or more destinations 14. Although the described communication manager 10 is particularly suited for use with telephone communications, the communication manager 10 disclosed herein can also equally be applied during other methods of communication, including electronic mail, anti-spam applications, messaging applications and telecopying, as non-exclusive examples.

As used herein, the term “source” 12 can include a specific communication device such as a telephone or other communicative device, a group 16 of communication devices including stand-alone devices and/or a network of devices. In these examples, the source 12 can be connected to a communication carrier 18 via communication equipment 20 such as a private branch exchange (PBX), a key system or an automatic call distributor, as non-exclusive examples. Further, as used herein, the term “destination” 14 can include a particular individual or business entity, or it can apply equally to include a specific location, such as a residence or business address, or other remote or networked locality, as non-exclusive examples. In FIG. 1, one representative destination 14 is depicted. It is recognized, however, that the present invention can be used with any number of destinations 14.

In one or more embodiments, an outgoing communication (not shown), which includes a destination sequence, can be generated at the source 12. The destination sequence can be input into the source 12 by a user (not shown), or the destination sequence can be automatically generated from the source 12 depending upon the specific source equipment used. For example, the destination sequence can be dialed or input into a keypad of a telephone at the source 12. In one embodiment, the destination sequence is a telephone number of the destination 14. The destination sequence is transmitted in the form of an electrical signal to the communication equipment 20. The destination sequence is then transmitted from the communication equipment 20 to the communication manager 10 by conventional transmission lines 22 such as a T1 line, plain old telephone service (POTS) lines, or any other recognized linkage known to those skilled in the art.

The communication manager 10 provided herein can be used in a variety of ways. For example, the communication manager 10 can be used with one source 12 or a group of sources 12. In one embodiment, one communication manager 10 can be used with each source 12. Alternatively, one communication manager 10 can be utilized with a plurality of sources 12. In another embodiment, one communication manager 10 can service all sources 12 associated with a particular business entity, building or group of buildings, or office or group of offices, as non-exclusive examples. As provided herein, the communication manager 10 can monitor and/or manage attempted outgoing telephone communications or other types of communications.

In the embodiment illustrated in FIG. 1, the communication manager 10 includes a sequence receiver 24, a database interface 26, and a controller 28. In this embodiment, the sequence receiver 24 is in electrical communication with the communication equipment 20. The sequence receiver 24 receives one or more destination sequences, each of which can include a single character or a string of characters of any length from the source 12 via the communication equipment 20 and the transmission lines 22.

The database interface 26 interfaces with one or more databases that store a plurality of database sequences. For example, in the embodiment illustrated in FIG. 1, the database interface 26 interfaces with a first database DB1, a second database DB2, a third database DB3 and a fourth database DB4. However, it is recognized that the database interface 26 can interface with fewer than four or greater than four databases DB1-DB4. As used herein, the first database DB1 includes a plurality of first database sequences, the second database DB2 includes one or more second database sequences, the third database DB3 includes one or more third database sequences, and the fourth database DB4 includes one or more fourth database sequences. If applicable, each successive database DBn would similarly includes one or more nth database sequences. It is recognized that the databases DB1-DB4 are numbered for convenience only, and that any database described herein can be the first database DB1, the second database DB2, etc.

As provided in greater detail below, the databases DB1-DB4 can be centralized, remotely located, and/or located within the communication manager 10. For example, one or more of the databases DB1-DB4 can be a centralized database that may be accessed by the database interface 26 via the Internet 30. In the embodiment illustrated in FIG. 1, DB1 and DB2 are maintained in a centralized location and are accessed using the Internet 30. In this example, the communication manager 10 can have one-way communication with DB1, so that the communication manager 10 can only import data from DB1 via the Internet. In this embodiment, the communication manager 10 can have two-way communication with DB2, so that both importing from DB2 and exporting to DB2 are permitted.

Additionally, the database DB3 can be maintained off-site in a location other than on the Internet 30. This third database DB3 can be periodically accessed by the database interface 26 as necessary. For example, the third database DB3 can be maintained as part of an Intranet or local area network, as non-exclusive examples. In this embodiment, the database, e.g. DB3, can be maintained separately from the communication manager 10, as illustrated in FIG. 1.

Further, a localized database DB4 can be stored within the communication manager 10. For example, data can be input by an administrator directly into the fourth database DB4, which is stored in the communication manager 10. Alternatively, the data can be obtained from another resource, and can be transferred and stored in the communication manager 10. This type of localized database DB4 can be manually or automatically updated on a predetermined, periodic basis, as required.

The controller 28 is in electrical communication with the sequence receiver 24 and/or the database interface 26. In the embodiment illustrated in FIG. 1, the controller 28 (and the other components of the communication manager 10) can be electrically positioned between the source 12 and the communication carrier 18. More specifically, in one embodiment, the controller 28 (and the other components of the communication manager 10) can be electrically positioned between the communication equipment 20 and the communication carrier 18.

As provided in greater detail below, the controller 28 can perform a comparison between the destination sequence and the database sequences included in any of the databases DB1-DB4. Further, the controller 28 can perform a comparison between one or more of the database sequences included in one of the databases DB1-DB4 and one or more of the database sequences included in any of the remaining databases. Additionally, the controller 28 can determine whether a sequence that is different from the destination sequence, such as one of the database sequences from any of the databases DB1-DB4, should be transmitted to the destination 14. Alternatively, the controller 28 can determine whether a sequence that is different from the destination sequence, such as one of the database sequences from any of the databases DB1-DB4, should be transmitted back to the source 12.

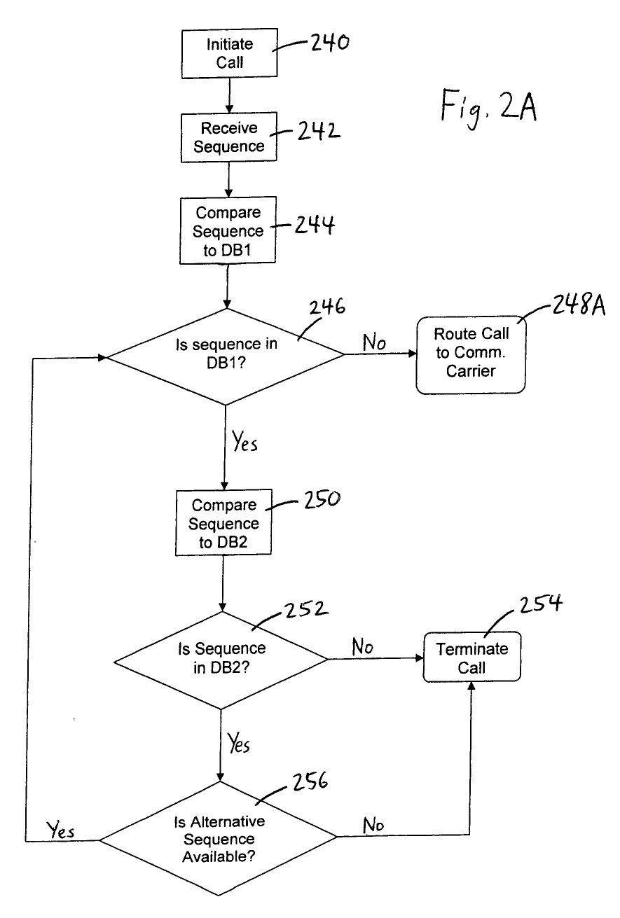

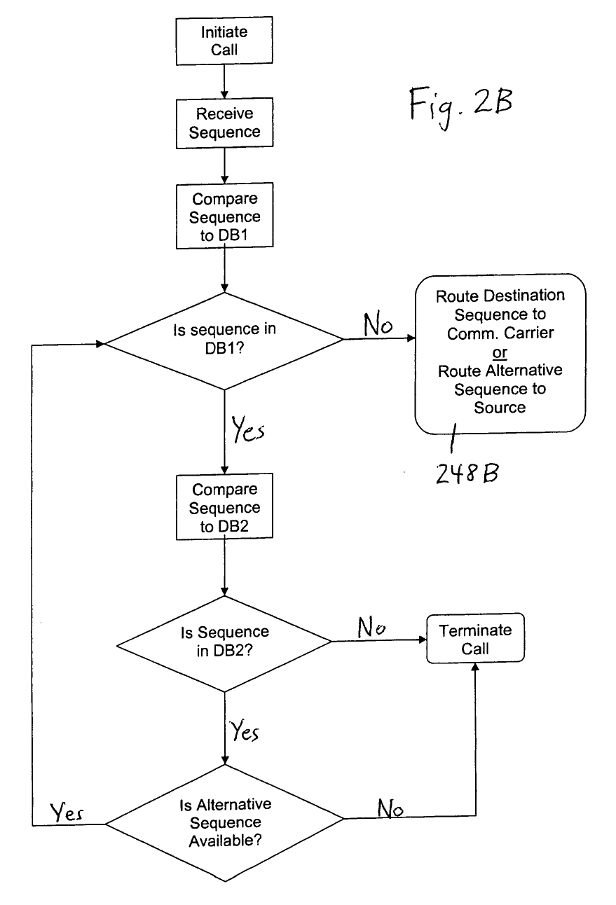

FIG. 2A is a flowchart that illustrates the steps involved in one embodiment of operation of the communication manager 10. For clarity, one or more of the components of the system is illustrated in FIG. 1. In this embodiment, the call is initiated from the source at step 240. The destination sequence is transmitted through the communication equipment 20 to the communication manager 10. The destination sequence is received by the sequence receiver 24 at step 242. The database interface 26 accesses DB1, which in this embodiment can be a DNC database that includes one or more first database sequences of prohibited telephone numbers. For example, the first database DB1 can include first database sequences from a federal or state DNC list, or any other prohibited sequence list.

The controller 28 can then compare the destination sequence with one, some or all of the database sequences in DB1 at step 244. Once the first database DB1 is queried at step 246, if the controller 28 determines that the destination sequence is not identical to any of the first database sequences in the first database DB1, the destination sequence is routed to the communication carrier 18 at step 248. On the other hand, if the controller 28 determines that the destination sequence is identical to one of the first database sequences in the first database DB1, the controller 28 compares the destination sequence to one or more of the second database sequences in DB2 at step 250.

In an alternative embodiment, once the first database DB1 is queried at step 246, if the controller 28 determines that the destination sequence is not substantially similar to any of the first database sequences in the first database DB1, the destination sequence is routed to the communication carrier 18 at step 248. On the other hand, if the controller 28 determines that the destination sequence is substantially similar to one of the first database sequences in the first database DB1, the controller 28 compares the destination sequence to one or more of the second database sequences in DB2 at step 250. It is recognized that each of the embodiments of the communication manager 10 provided herein can be changeably programmed as necessary so that either an identical match is required, or a substantially similar match is required.

As used herein during the above comparison, to be “identical”, the entire destination sequence must completely match one of the first database sequences in the first database. Further, as used herein, “substantially similar” can mean that a predetermined number or percentage of characters in the destination sequence are either sequentially included, or alternatively, are non-sequentially included in one of the first database sequences. For example, with reference to a standard 10-character telephone number including a three-character area code and a seven-character phone number, substantially similar can mean that the seven characters of the phone number sequentially match all seven characters of one of the first database sequences. The number of matching characters necessary for substantial similarity can vary depending upon the design requirements of the communication manager 10.

Still alternatively, substantially similar can mean that the seven characters (excluding the area code) of the phone number sequentially match the corresponding seven characters of one of the first database sequences, and that the area code of the first database sequence is one of a specific number of area codes in the geographical vicinity of the area code of the destination sequence. The foregoing are only representative examples of how the destination sequence can be determined by the controller 28 to be substantially similar to one of the first database sequences. It would be an impossibility to list all possible examples of “substantially similar” herein. Of course, this comparison can apply to any of the database sequences in any of the databases DB1-DB4.

In the embodiment shown in FIG. 2A, the second database sequences in the second database DB2 can include the destination sequence and additional information that is associated with the destination sequence and/or the destination 14. For example, such information may include one or more alternative sequences, e.g. alternative telephone numbers for the destination 14. In this example, the destination 14 may have provided a plurality of telephone numbers to the source 12, of which one or more such telephone numbers are not included in the first database DB1 of prohibited telephone numbers.

In this embodiment, if the controller 28 determines at step 252 that the destination sequence is not substantially similar to any of the second database sequences in the second database DB2, the communication is terminated at step 254. However, if the controller 28 determines at step 252 that the destination sequence is identical or substantially similar to one of the second database sequences, the second database DB2 is queried at step 256 whether an alternative sequence for the destination 14 is available. If no alternative sequence is available, the call is terminated at step 254. If an alternative sequence is available, the alternative sequence is compared with one or more of the first database sequences in the first database DB1, and the process of steps 246-256 is repeated as necessary until either the call is routed to the communication carrier 18 (at step 248), or the call is terminated (at step 254).

FIG. 2B shows the steps included in an alternative embodiment of the operation of the communication manager 10. In this embodiment, the steps are somewhat similar to those described with respect to FIG. 2A, with one primary exception. Instead of automatically routing the alternative sequence directly to the communication carrier 18 if the alternative sequence is not identical or substantially similar to any of the first database sequences as illustrated at step 248A in FIG. 2A, the alternative sequence is routed back to the source 12 in step 248B. The source 12 can then be queried as to whether or not the call should then be routed to the communication carrier 18 utilizing the alternative sequence.

The manner of querying the source 12 can vary widely. In one embodiment, an audible message is sent from the communication manager 10 to the source 12 using MP3 capabilities. However, other types of audible messages can be sent by the communication manager 10 to the source 12. Additionally, the source 12 can be notified of the alternative sequence by facsimile, text message, LED readout, electronic mail, and/or instant messenger, as non-exclusive examples. Alternatively, any other communicative device (not shown) known to those skilled in the art can be used in conjunction with the communication manager 10 to provide the source 12 with the alternative sequence, provided an appropriate interface and/or electrical connection between the communication manager 10 and the communicative device is in place.

In another embodiment, the communication manager 10 can query the source 12 regarding the specific manner that the source 12 would like the alternative sequence to be communicated to the source 12. For example, the communication manager 10 can provide the source 12 with an audible message requesting the source 12 to press a particular key on a keypad, or audibly respond to the message from the communication manager depending upon the manner that the source 12 would like the alternative sequence to be provided.

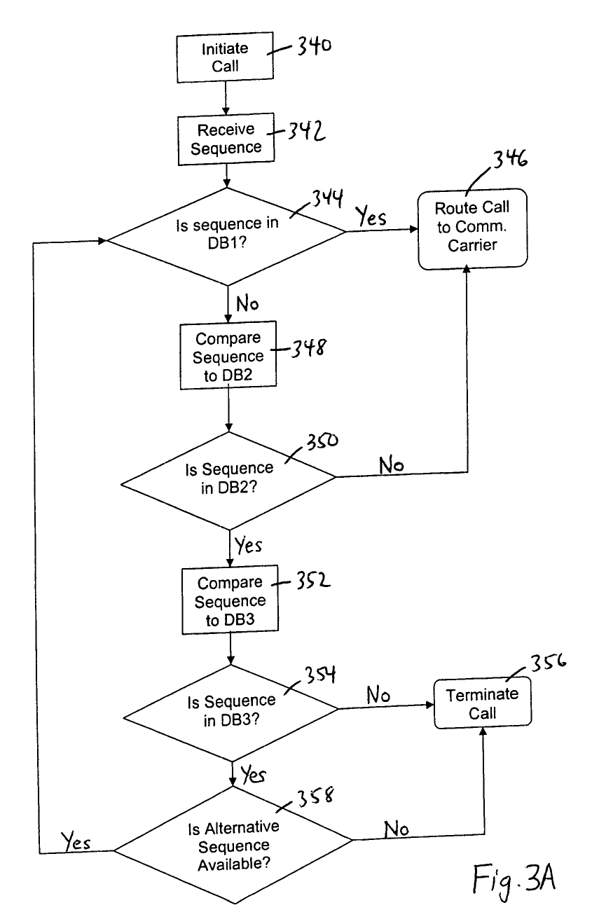

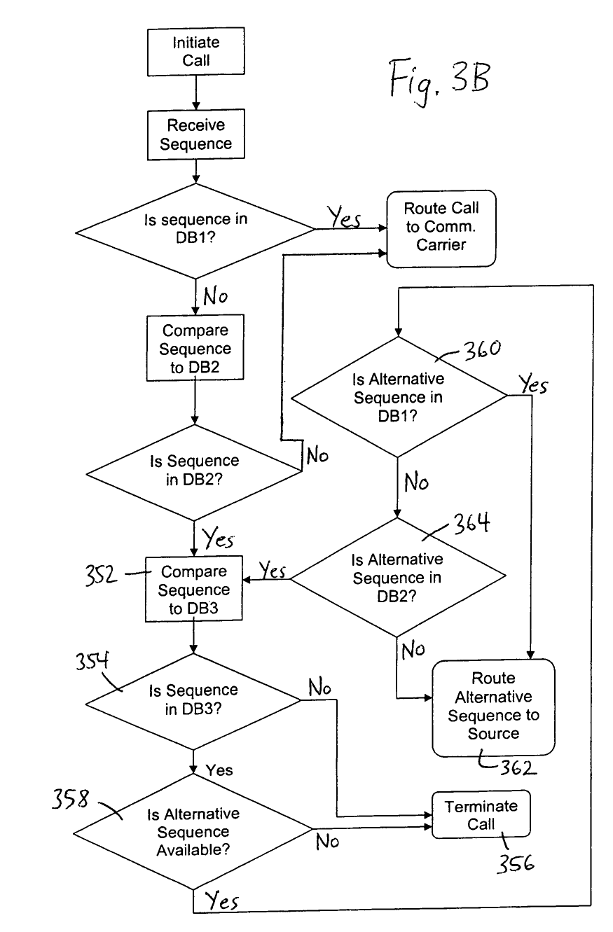

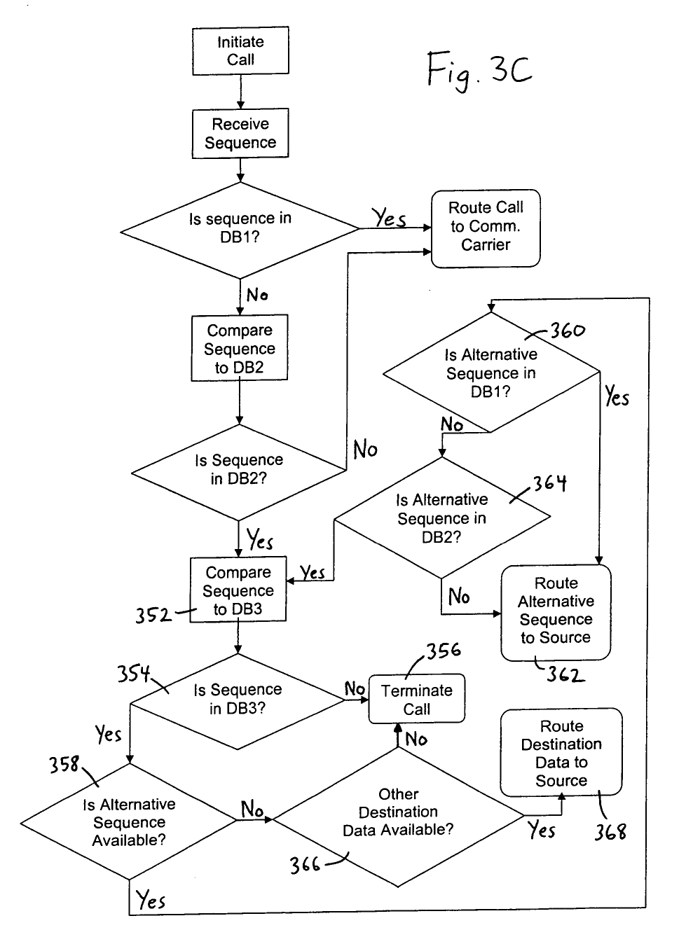

FIG. 3A is a flowchart that illustrates the steps involved in another embodiment of operation of the communication manager 10. For clarity, one or more of the components of the system is illustrated in FIG. 1. The call is initiated at step 340. The destination sequence is received by the sequence receiver 24 at step 342. The database interface 26 accesses DB1, which in this embodiment can be an allowed list of first database sequences that may be included in a pre-approved customer list or another similar list of database sequences. In this embodiment, DB1 includes database sequences which one or more destinations 14 have consented to provide for use by the source regardless of whether or not such database sequence is included on a DNC database.

The controller 28 can then compare the destination sequence with one, some or all of the database sequences in DB1. Once the first database DB1 is queried at step 344, if the controller 28 determines that the destination sequence is identical to any of the first database sequences in the first database DB1, the destination sequence is routed to the communication carrier 18 at step 346. In an alternative embodiment, if the controller 28 determines that the destination sequence is substantially similar to any of the first database sequences in the first database DB1, the destination sequence is routed to the communication carrier 18 at step 346. On the other hand, if the controller 28 determines that the destination sequence is not identical or substantially similar to one of the first database sequences in the first database DB1, the controller 28 compares the destination sequence to one or more of the second database sequences in DB2 at step 348.

The database interface 26 accesses DB2, which in this embodiment can be a DNC database that includes one or more second database sequences of prohibited telephone numbers. For example, the second database DB2 can include second database sequences from a federal, state or other DNC list.

Once the second database DB2 is queried at step 350, if the controller 28 determines that the destination sequence is not identical or substantially similar to any of the second database sequences in the second database DB2, the destination sequence is routed to the communication carrier 18 at step 346, and the call is placed. On the other hand, if the controller 28 determines that the destination sequence is identical or substantially similar to one of the second database sequences in the second database DB2, the controller 28 compares the destination sequence to one or more of the third database sequences in DB3 at step 352.

In this embodiment, the third database sequences in the third database DB3 can include the destination sequence and additional information that is associated with the destination sequence and/or the destination 14. For example, such information may include one or more alternative telephone numbers for the destination 14. In this example, the destination 14 may have provided a plurality of telephone numbers to the source 12, of which one or more such telephone numbers are not included in the second database DB2 of prohibited telephone numbers.

In this embodiment, if the controller 28 determines at step 354 that the destination sequence is not substantially similar to any of the third database sequences in the third database DB3, the communication is terminated at step 356. However, if the controller 28 determines at step 354 that the destination sequence is identical or substantially similar to one of the third database sequences, the third database DB3 is queried at step 358 whether an alternative sequence for the destination 14 is available. If no alternative sequence is available, the call is terminated at step 356. However, if an alternative sequence is available, the alternative sequence is compared with one or more of the first database sequences in the first database DB1, and the process of steps 344-358 is repeated as necessary until either the call is routed to the communication carrier 18 (at step 346), or the call is terminated (at step 356).

FIG. 3B is a flowchart that illustrates the steps involved in another embodiment of operation of the communication manager 10. For clarity, one or more of the components of the system is illustrated in FIG. 1. In this embodiment, the steps are somewhat similar to those described with respect to FIG. 3A, with one primary exception. Once the controller 28 determines that an alternative sequence is available at step 358, the controller 28 compares the alternative sequence with one or more of the first sequences in the first database DB1.

The first database DB1 is queried whether the alternative sequence is identical (or substantially similar) to any of the first database sequences in the first database DB1 at step 360. If upon comparison, the controller 28 determines that this query is answered in the affirmative, the alternative sequence is routed to the source 12 at step 362 in a manner previously described. However, if upon comparison, the controller 28 determines that this query is answered in the negative, the controller 28 then queries the second database DB2 whether the alternative sequence is identical or substantially similar to any of the second database sequences in the second database DB2 at step 364.

If the alternative sequence is not identical (or substantially similar) to any of the second database sequences in the second database DB2, the alternative sequence is routed to the source 12 at step 362 as previously described. If the alternative sequence is identical (or substantially similar) to any of the second database sequences in the second database DB2, then the alternative sequence is compared to one or more of the third sequences in the third database DB3 at step 352, and the cycle including one or more of steps 352-364 is repeated as many times as necessary until the alternative sequence is routed to the source 12 at step 362 or the call is terminated at step 356.

FIG. 3C is a flowchart that illustrates the steps involved in another embodiment of operation of the communication manager 10. For clarity, one or more of the components of the system is illustrated in FIG. 1. In this embodiment, the steps are somewhat similar to those described with respect to FIG. 3B, with one primary exception. In the event it is determined at step 358 that an alternative sequence to the destination sequence is not available in DB3, the call is not immediately terminated at step 356. Instead, the third database DB3 is queried whether any other information regarding the destination 14 is present, at step 366.

For example, the third database DB3 may contain data including a location/address, facsimile number, electronic mail address, instant messenger address, web address, or any other pertinent information regarding the destination 14. If such other destination data is present in the third database DB3, this destination data can be routed to the source 12 at step 368 in a manner previously described herein. If no such other destination data is present in the third database DB3, the call can then be terminated at step 356.

As an example of the operation of the embodiment described with reference to FIG. 3C, the destination sequence may be a telephone number of a destination 14, such as a consumer. In this example, the telephone number may not be present in the first database DB1 (allowed list, current customer list, etc.). However, the telephone number may be present in the second database DB2 (prohibited list, DNC list, etc.). The telephone number is then searched in the third database DB3 in an attempt to cross-reference one or more alternative telephone numbers that the consumer may have provided to the source 12 at one time.

If an alternative telephone number for the consumer is found, the alternative telephone number is screened by comparison to the first database sequences in the first database DB1, and any successive databases (i.e. DB2, DB3), if necessary, as described above. If an alternative telephone number for the consumer is not found in the third database DB3, then the third database DB3 is reviewed for any additional data that may be of assistance in contacting the consumer in an acceptable manner. For example, a mailing address for the consumer may be present in the third database DB3. The source 12 may then be able to use this mailing address to request consent to contact the consumer by telephone or by other appropriate means. In one embodiment, if a mailing address of the consumer is present in the third database DB3, the communication manager 10 can send a signal to the source 12 to automatically prepare and send a mailer to be sent by mail to the consumer. Alternatively, an electronic mail message could be automatically sent to the consumer in the event the other destination data included an electronic mail address of the consumer. The foregoing examples are representative only, and are not intended to limit the scope of the present invention in any manner.

Additionally, it should be recognized that the communication manager 10 provided herein can be utilized simultaneously with a plurality of prohibited number databases or Do-Not-Call databases. For example, the database interface 26 can interface with a state DNC database, a federal DNC database, and/or any other DNC databases in series or in parallel. The examples provided herein, and the specific number of databases described are not intended to limit the breadth and scope of the present invention.

While the particular communication manager 10 and method for managing outgoing communication attempts as herein shown and disclosed in detail are fully capable of obtaining the objects and providing the advantages herein before stated, it is to be understood that they are merely illustrative of various embodiments of the invention. No limitations are intended to the details of construction or design herein shown other than as described in the appended claims.

What is claimed is:

1. A communication manager for managing outgoing destination sequences including a first destination sequence that originates from a source for communication with a destination via a communication carrier, the communication manager comprising:
a sequence receiver that receives the first destination sequence from the source during an outgoing communication;
a database interface that interfaces with (i) a first database including a plurality of first database sequences, and (ii) a separate second database including a second database sequence; and
a controller that is in electrical communication with the sequence receiver and the database interface, the controller comparing the first destination sequence to one or more of the first database sequences; wherein the controller selectively transmits the second database sequence to one of the communication carrier and the source depending upon (i) whether the first destination sequence is substantially similar to one of the first database sequences, and (ii) whether the second database sequence is substantially similar to one of the first database sequences in the first database.

2. The communication manager of claim 1 wherein the controller only transmits the second database sequence when the first destination sequence is substantially similar to one of the first database sequences.

3. The communication manager of claim 1 wherein the controller only transmits the second database sequence when the second database sequence is not substantially similar to one of the first database sequences.

4. The communication manager of claim 3 wherein the controller only transmits the second database sequence when the first destination sequence is substantially similar to one of the first database sequences.

5. The communication manager of claim 4 wherein the controller transmits the second database sequence to the source.

6. The communication manager of claim 5 wherein the second database sequence includes an alternative telephone number for the destination.

7. The communication manager of claim 5 wherein the second database sequence is selected from the group consisting of a mailing address of the first destination, a facsimile number of the first destination, a web address of the first destination, an electronic mail address of the first destination and an instant messenger username of the first destination.

8. The communication manager of claim 5 wherein the second database sequence is communicated to the source by a communication means selected from a group consisting of electronic mail, text message, facsimile and audio transmission.

9. The communication manager of claim 4 wherein the controller transmits the second database sequence to the communication carrier.

10. The communication manager of claim 9 wherein the second database sequence includes an alternative telephone number for the destination.

11. The communication manager of claim 4 wherein the second database includes a plurality of telephone sequences on an allowed customer list.

12. The communication manager of claim 11 wherein the second database includes at least one of the first database sequences.

13. The communication manager of claim 12 wherein the second database sequence is not included within the first database.

14. The communication manager of claim 1 wherein the controller is electrically positioned between the source and the communication carrier.

15. The communication manager of claim 1 wherein the database interface and the controller are each electrically positioned between the source and the communication carrier.

16. The communication manager of claim 1 wherein the first database includes a plurality of telephone sequences on a do-not-call list.

17. The communication manager of claim 1 wherein the controller only transmits the second database sequence when the first destination sequence is identical to one of the first database sequences.

18. The communication manager of claim 1 wherein the controller only transmits the second database sequence when the first destination sequence is not substantially similar to one of the first database sequences, and the second database sequence is substantially similar to one of the first database sequences in the first database.

19. The communication manager of claim 18 wherein the database interface interfaces with a separate third database that includes a plurality of third database sequences, and wherein whether the controller selectively transmits the second database sequence depends upon whether the second database sequence is substantially similar to any of the third database sequences.

20. A communication manager for managing outgoing destination sequences including a first destination sequence that originates from a source for communication with a destination via a communication carrier, the communication manager comprising:
a sequence receiver that receives the first destination sequence from the source during an outgoing communication;
a database interface that interfaces with a do-not-call database including a plurality of prohibited telephone sequences, and a separate second database including a second database sequence; and
a controller that is in electrical communication with the sequence receiver and the database interface, the controller comparing the first destination sequence to one or more of the prohibited telephone sequences; wherein the controller transmits the second database sequence to the communication carrier as an alternative to the first destination sequence when the first destination sequence is identical to one of the prohibited telephone sequences and the second database sequence is different than each of the prohibited telephone sequences.

21. The communication manager of claim 20 wherein the transmission of the second database sequence to the communication carrier is transparent to the source.

22. A communication manager for managing outgoing destination sequences including a first destination sequence that originates from a source for communication with a destination via a communication carrier, the communication manager comprising:
a sequence receiver that receives the first destination sequence from the source during an outgoing communication;
a database interface that interfaces with a do-not-call database including a plurality of prohibited telephone sequences, and a separate second database including a second database sequence; and
a controller that is in electrical communication with the sequence receiver and the database interface, the controller comparing the first destination sequence to one or more of the prohibited telephone sequences; wherein the controller transmits the second database sequence to the source as an alternative to the first destination sequence when the first destination sequence is identical to one of the prohibited telephone sequences and the second database sequence is different than each of the prohibited telephone sequences.

23. A method for managing outgoing destination sequences originating from a source for communication with a destination via a communication carrier, the method comprising the steps of:
receiving a destination sequence from the source with a sequence receiver;
interfacing with a first database including a plurality of first database sequences and a separate second database including a second database sequence using a database interface; and
selectively transmitting the second database sequence to one of the source and the destination with a controller, the transmission depending upon whether (i) the first destination sequence is substantially similar to one of the first database sequences, and (ii) the second database sequence is substantially similar to one of the first database sequences in the first database.

24. The method of claim 23 wherein the controller is electrically positioned between the source and the communication carrier.

25. The method of claim 23 wherein the step of transmitting includes transmitting the second database sequence only when the first destination sequence is substantially similar to one of the first database sequences.

26. The method of claim 23 wherein the step of transmitting includes transmitting the second database sequence only when the second database sequence is not substantially similar to one of the first database sequences.

27. The method of claim 26 wherein the step of transmitting includes transmitting the second database sequence only when the first destination sequence is substantially similar to one of the first database sequences.

28. The method of claim 27 wherein the step of transmitting includes transmitting the second database sequence to the source.

29. The method of claim 28 wherein the second database sequence includes an alternative telephone number for the destination.

30. The method of claim 28 wherein the second database sequence is selected from the group consisting of a mailing address of the first destination, a facsimile number of the first destination, a web address of the first destination, an electronic mail address of the first destination and an instant messenger username of the first destination.

31. The method of claim 28 wherein the step of transmitting includes communicating the second database sequence to the source by a communication means selected from the group consisting of electronic mail, text message, facsimile and audio transmission.

32. The method of claim 27 wherein the step of transmitting includes transmitting the second database sequence to the communication carrier.

33. The method of claim 32 wherein the second database sequence includes an alternative telephone number for the destination.

34. The method of claim 27 wherein the second database includes a plurality of telephone sequences on an allowed customer list.

35. The method of claim 34 wherein the second database includes at least one of the first database sequences.

36. The method of claim 35 wherein the second database sequence is not included within the first database.

37. The method of claim 23 wherein the first database includes a plurality of telephone sequences on a Do-Not-Call list.

38. The method of claim 23 wherein the step of transmitting includes transmitting the second database sequence only when the first destination sequence is identical to one of the first database sequences.

39. The method of claim 23 wherein the step of transmitting includes transmitting the second database sequence only when (i) the first destination sequence is not substantially similar to one of the first database sequences, and (ii) the second database sequence is substantially similar to one of the first database sequences in the first database.

40. The method of claim 39 wherein the step of interfacing includes the database interface interfacing with a separate third database that includes a plurality of third database sequences, and wherein the step of transmitting includes transmitting the second database sequence depending upon whether the second database sequence is substantially similar to any of the third database sequences.
